(19) United States
(12) Patent Application Publication
(10) Pub. No.: US 2026/0014448 A1
(43) Pub. Date: Jan. 15, 2026

(54) Real-Time Football Play Instruction and Training System

(71) Applicant: Ferris Moore, Auburn, AL (US)

(72) Inventor: Ferris Moore, Auburn, AL (US)

(21) Appl. No.: 19/259,561

(22) Filed: Jul. 3, 2025

Related U.S. Application Data
(60) Provisional application No. 63/668,803, filed on Jul. 9, 2024.

(51) Int. Cl. A63B 71/06; G06F 3/0488; G06F 3/14; G09G 3/00; H04R 1/02

(52) U.S. Cl. CPC A63B 71/0622; G06F 3/0488; G06F 3/14; G09G 3/001; H04R 1/028; A63B 2071/0666; A63B 2225/50; A63B 2243/007; G09G 2354/00; H04R 2499/15

(57) ABSTRACT

A football training system that includes a remote device configured to design and transmit football plays to helmet-mounted visors via a wireless network is disclosed. A visor comprises a transparent digital display, a wireless communication module, a processor, and a display driver. The processor interprets the received play data and renders a position-specific visual representation directly within the player's or wearer's line of sight before the snap. The remote device enables coaches to customize plays and assign them to specific players. The visor remains in a clear standby mode until activated by incoming play data. The system also supports player-specific tracking of response times and play repetitions for performance analysis.

### CROSS REFERENCE TO RELATED APPLICATION

The present application claims priority to, and the benefit of U.S. Provisional Application No. 63/668,803 which was filed on Jul. 9, 2024, and is incorporated herein by reference in its entirety.

### FIELD OF THE INVENTION

The present invention generally relates to wearable athletic training devices and augmented reality sports technology. More specifically, the present invention relates to a visor-based football training system configured to deliver real-time, position-specific play instructions directly within a player's or wearer's line of sight. The invention comprises a transparent visor integrated into a football helmet, equipped with a digital display, wireless communication module, and onboard processor. The visor is operatively connected to a remote device, such as a tablet or smartphone, which enables a coach to select, customize, and transmit football plays wirelessly to one or more players. The visor remains visually clear in standby mode and activates upon receiving data, projecting individual assignments and route diagrams without obstructing field vision. Accordingly, the present disclosure makes specific reference thereto. Nonetheless, it is to be appreciated that aspects of the present invention are also equally applicable to other like applications, devices, and methods of manufacture.

### BACKGROUND

By way of background, football training includes communicating plays to players. Traditional methods of communicating plays such as verbal instruction, hand signals, or team huddles, break rhythm of the training and reduce practice efficiency. Coaches often need to stop drills or gather players into huddles to relay play information, which interrupts the natural flow of practice sessions and consumes valuable time. Furthermore, players frequently struggle with memorizing complex plays and position assignments.

The lack of real-time, individualized instruction contributes to miscommunication, slower development, and reduced practice intensity. Sending in plays one at a time not only disrupts rhythm but also limits the number of repetitions possible within a training period. Accordingly, players and coaches require a system that can deliver customized play information directly and instantly to each player.

Therefore, there exists a long-felt need in the art for a system that improves the efficiency of football practice by reducing or eliminating the need for huddles and repeated verbal instruction. There is a long-felt need for a wearable display system that enables players to receive real-time, position-specific play instructions visually, without disrupting the flow of practice. Furthermore, there is a need for a helmet-integrated system that delivers customized play diagrams to individual players remotely via a remote device. Additionally, there is a long-felt need in the art for a practice tool that reinforces play memorization through consistent visual exposure, thereby enhancing player development. Finally, there is a long-felt need for a football training system that helps players remember plays through constant visual reinforcement.

The subject matter disclosed and claimed herein, in one embodiment, comprises a football play heads-up display system designed to enhance practice performance through real-time visual instruction. The system includes a remote device operable by a coach or trainer and configured to create, modify, and transmit play data over a wireless network. The remote device may be a standalone controller or a general-purpose device such as a tablet or smartphone running a dedicated application. The system further includes a visor assembly mounted to a standard football helmet. The visor comprises a transparent digital display, a processor, a display driver module, and a wireless communication module. The processor interprets received data and drives the display to show play content such as routes or assignments within the player's or wearer's field of view.

In one embodiment, the visor display operates in a clear standby mode until it receives an incoming transmission. Once play data is received, the visor renders a position-specific view of the play, enabling the player to quickly and accurately understand their assignment before the snap. The system can deliver tailored visual instructions to each individual visor based on positional role, enabling different players to view different elements of the same play simultaneously.

In this manner, the football play heads-up display system of the present invention addresses longstanding inefficiencies in current football practice methods. The invention eliminates the need for frequent huddles, verbal repetition, and hand-signal confusion by delivering personalized, visual play instructions directly to players in real time by offering a clear visor that includes a clear digital graphic display of plays, visible to football players. The system promotes faster practice pacing, improves player recall, and facilitates better learning through visual reinforcement.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a football training system. The system includes a remote device configured to enable a user to design, customize, and transmit football play data. A visor assembly is mountable to a helmet, the visor assembly comprises a transparent digital display configured to display the football play data within a player's or wearer's line of sight, a wireless module is configured to receive the football play data from the remote device over the network, a processor is configured to interpret the football play data, and a display driver module is electrically connected to the processor and configured to render a position-specific view of the football play data on the transparent digital display. The visor assembly is configured to operate in a standby mode where the transparent digital display remains clear until play data is received.

In another embodiment, a method of providing football play information to a player during training is disclosed. The method includes selecting or designing a football play using a remote device, transmitting the football play wirelessly to a visor integrated into a helmet worn by the player, receiving the football play at the visor using a wireless module, interpreting the received football play with a processor located in the visor, and rendering a position-specific view of the football play on a transparent digital display of the visor before the football snap occurs.

In one embodiment, a visor apparatus for use in a football helmet training system is disclosed. The visor apparatus includes one or more attachment members configured to mount the visor apparatus to a helmet, a transparent digital display is configured to overlay visual play content within a player's or wearer's field of view, a processor is configured to decode play data received wirelessly, a wireless communication module is configured to receive football play data from a remote computing device, a display driver is electrically connected to the processor and the transparent digital display to render play content specific to the player's or wearer's role, a microphone is configured for voice commands or communication, wherein the visor apparatus is configured to visually reinforce play memorization and improve training efficiency by providing real-time visual instructions.

In still another embodiment, the player response time and play repetitions are tracked and stored for performance analysis and training optimization.

In yet another embodiment, the transparent digital display is configured to operate in a standby mode in which it remains visually clear until football play data is received and automatically transitions to a display mode upon receipt of the data.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of football play heads-up display system of the present invention in accordance with the disclosed structure;

FIG. 2 illustrates a standalone view of the visor used in the football play heads-up display system of the present invention in accordance with the disclosed structure;

FIG. 3 illustrates a perspective view of the remote device showing creation of a customized play in accordance with the disclosed structure;

FIG. 4 illustrates a flow chart depicting the operational method of transmitting and displaying play information using the visor-based football training system in accordance with one embodiment of the present invention;

FIG. 5 illustrates a flowchart depicting a method of delivering personalized play instructions and monitoring player performance using the visor-based football training system, in accordance with an embodiment of the present invention;

FIG. 6 illustrates a flowchart depicting a method of visor operation during a training session using the intelligent football visor system, in accordance with one embodiment of the present invention; and

FIG. 7 illustrates an exemplary remote device used in the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a system that improves the efficiency of football practice by reducing or eliminating the need for huddles and repeated verbal instruction. There is a long-felt need for a wearable display system that enables players to receive real-time, position-specific play instructions visually, without disrupting the flow of practice. Furthermore, there is a need for a helmet-integrated system that delivers customized play diagrams to individual players remotely via a remote device. Additionally, there is a long-felt need in the art for a practice tool that reinforces play memorization through consistent visual exposure, thereby enhancing player development. Finally, there is a long-felt need for a football training system that helps players remember plays through constant visual reinforcement.

The present invention, in one exemplary embodiment, is a visor apparatus for use in a football helmet training system. The visor apparatus includes one or more attachment members configured to mount the visor apparatus to a helmet, a transparent digital display is configured to overlay visual play content within a player's or wearer's field of view, a processor is configured to decode play data received wirelessly, a wireless communication module is configured to receive football play data from a remote computing device, a display driver is electrically connected to the processor and the transparent digital display to render play content specific to the player's or wearer's role, a microphone is configured for voice commands or communication, wherein the visor apparatus is configured to visually reinforce play memorization and improve training efficiency by providing real-time visual instructions.

Reference will now be made in detail to the present preferred embodiments of the invention, examples of which are illustrated in the accompanying drawings. Wherever possible, the same reference numerals are used in the drawings and the description to refer to the same or like parts.

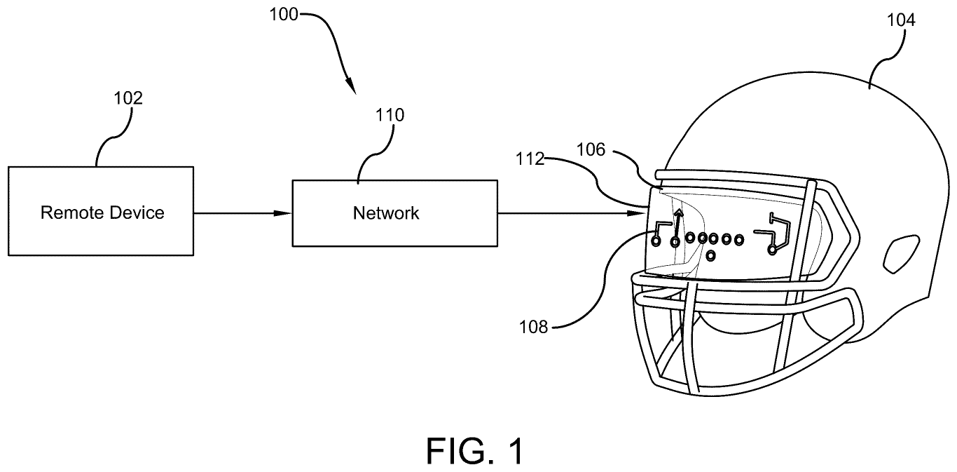

Referring initially to the drawings, FIG. 1 illustrates a schematic view of a football play heads-up display system of the present invention in accordance with the disclosed structure. The football play heads-up display system 100 of the present invention is designed as a football visor system to enhance football training. The system 100 includes a remote device 102 which can be used by a coach or trainer and is configured to wirelessly communicate with a visor 106 equipped in a helmet 104. The remote device 102 can be a standalone physical device or may also be in the form of a tablet, smartphone, or other computing device running a dedicated application configured to select, generate, and transmit football plays or instructional content.

More specifically, the remote device 102 communicates with the visor-equipped helmet 104 via a network 110, which may include a local wireless protocol such as Bluetooth or Wi-Fi, or a broadband connection such as 3G, 4G, or 5G. In operation, the remote device 102 transmits digital play data through the network 110, which is then received by the visor 106 as described later in the disclosure.

The visor 106 includes a transparent digital display 112 which is configured to display play diagrams or route information 108 directly within a player's or wearer's line of sight wearing the helmet 104. The play diagrams or route information 108 are preferably position-specific and real-time, enabling players to review and memorize their roles before each snap without needing a verbal huddle. The digital display 112 is transparent and remains clear (standby mode) enabling full visual awareness of the field. Further, when the play diagrams or route information 108 is displayed, the digital display 112 provides full visual awareness.

It should be noted that the system 100 enables coaches to provide play information to different players and players can see the routes and position assignments before each snap through the visor 106. Accordingly, the system 100 reduces time spent in huddles or verbally relaying plays, enabling more reps in less time. The visor 106 provides constant visual exposure to plays which helps reinforce memory of players and each visor can display custom information tailored to a player's or wearer's role or assignment.

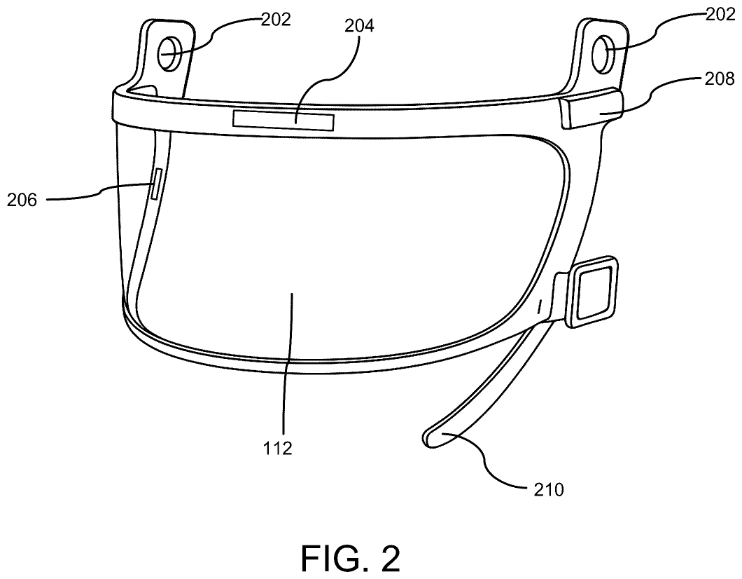

FIG. 2 illustrates a standalone view of the visor used in the football play heads-up display system of the present invention in accordance with the disclosed structure. The visor assembly 106 includes the curved, transparent display 112 and is configured to be mounted to a helmet via one or more attachment members 202. The attachment members 202 enable secure and adjustable installation to standard helmet models without impacting the functionality of the helmet.

A processor 204 is included in the visor assembly 106 and receives, interprets, and manages digital data corresponding to football plays or assignments. The processor 204 decodes the wireless signals received from the remote device 102 and is also electrically connected to a display driver module 206. The display driver module 206 is configured to render digital images or route maps on the digital display 112 integrated into the visor surface.

A wireless module 208 is also integrated into the visor assembly 106 and enables wireless communication with external devices such as the remote device 102 via the network (as shown in FIG. 1). In the preferred embodiment, the wireless module 208 facilitates the real-time reception of data from the remote device, such as a tablet or smartphone operated by a coach. Additionally, the visor assembly 106 includes a microphone 210. The microphone 210 can optionally be used for audio feedback, audio transmission, voice command functionality, or sideline communication, depending on the requirements of users.

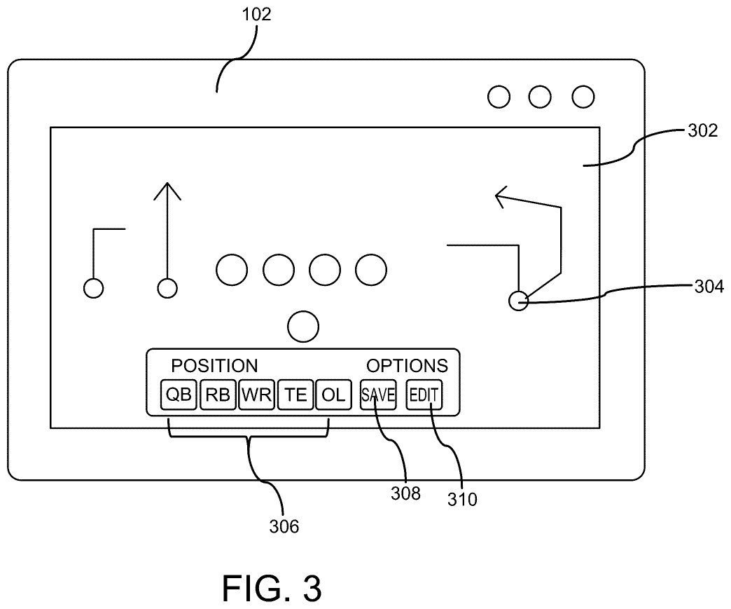

FIG. 3 illustrates a perspective view of the remote device showing creation of a customized play in accordance with the disclosed structure. The remote device 102 includes a digital display 302, which is configured to display user interfaces for interaction by a coach or authorized operator. The display 302 is touch enabled and shows a customized and editable play 304, comprising player positions, route diagrams, and tactical or position assignments. Using the touch display 302, the play 304 can be customized as per the requirements of the team.

The display 302 provides a set of player/visor identifiers 306. The identifiers enable a coach to assign the selected play to specific helmet visors or player positions, for example quarterback (QB), running back (RB), wide receiver (WR), tight end (TE), and offensive lineman (OL). The identifiers 306 enable targeted play delivery and position-specific visualization.

A SAVE icon 308 enables the coach to store the current play and initiate the transmission thereof to the designated visors. An EDIT button 310 enables the operator or coach to modify the play diagram 304 directly on the screen 302, facilitating on-the-fly updates during practice sessions.

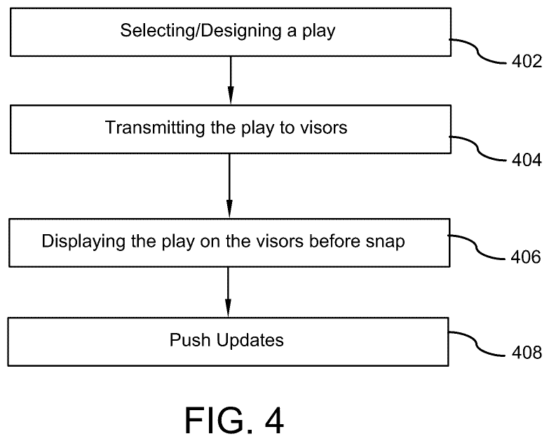

FIG. 4 illustrates a flow chart depicting the operational method of transmitting and displaying play information using the visor-based football training system in accordance with one embodiment of the present invention. Initially, a coach or authorized user begins by selecting or designing a play using the interface on the remote device, such as a tablet or smartphone (Step 402). Designing the play may include drawing routes, assigning player roles, and customizing position-specific instructions.

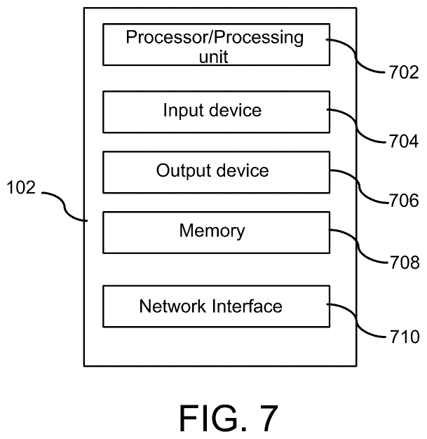

Then, the play is transmitted wirelessly to visors worn by players via the wireless network. The transmission is preferably handled by a communication module embedded in the remote device 102 (shown in FIG. 7) and the wireless module 208 of the visor units (Step 404). Thereafter, the transmitted play is displayed on the transparent visors worn by players (Step 406). Preferably, the display is shown prior to the snap, enabling each player to visually confirm their individual assignment without the need for verbal communication or a huddle. In some embodiments, the play is displayed for a preconfigured duration such as 20 seconds and more and may not be displayed after the snap. Finally, using the remote device 102, push notifications for adjustments or revisions in the play are transmitted to the visor assemblies for improving responsiveness and in-practice adaptability (Step 408).

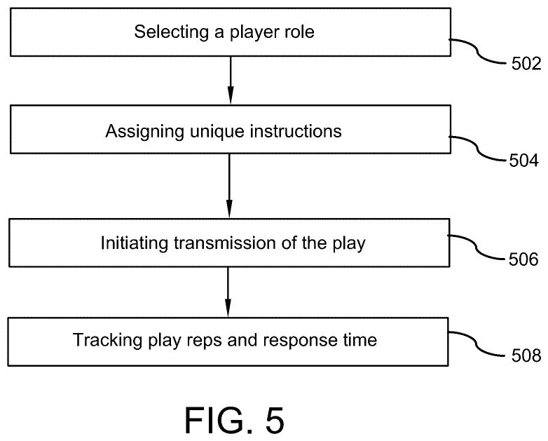

FIG. 5 illustrates a flowchart depicting a method of delivering personalized play instructions and monitoring player performance using the visor-based football training system, in accordance with an embodiment of the present invention. Initially, a coach using the remote device 102, selects a player role which enables the coach or operator to target specific positions such as quarterback, wide receiver, lineman, or running back (Step 502). Then, customized instructions are assigned to the selected player role (Step 504). The instructions may include position-specific routes, blocking assignments, or motion cues that are part of a larger team play strategy.

In the next step, transmission of the play to the helmet visor worn by the selected player is initiated before snap (Step 506). The play data is wirelessly sent via a network from the remote device 102 to the player's or wearer's visor display module 112. Finally, the system performs tracking of play repetitions and response time (Step 508). The tracking may involve logging when a player receives a play, how frequently the player repeats the play, and their reaction or execution timing. The collected data can be used for performance analysis, training optimization, or play recall improvement.

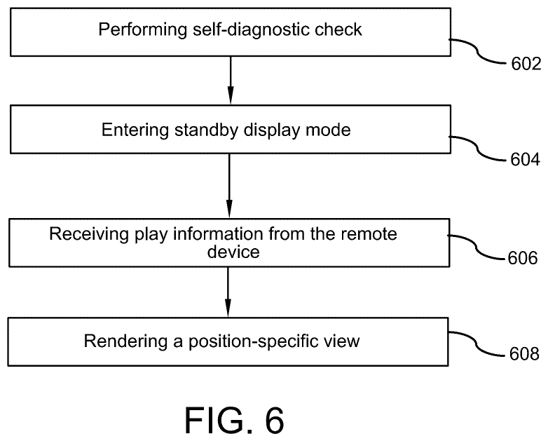

FIG. 6 illustrates a flowchart depicting a method of visor operation during a training session using the intelligent football visor system, in accordance with one embodiment of the present invention. Initially, the visor assembly 106 initiates a self-diagnostic check (Step 602). The self-diagnostic check checks that internal components such as the display 112, wireless receiver 208, processor 204, and other components are functioning properly before use.

Once the diagnostic check is successfully performed, the visor assembly 106 transitions into standby display mode (Step 604). In the standby mode, the visor remains clear and unobstructed, awaiting incoming play instructions from a remote device. Then, the visor assembly 106 receives play information from the remote device 102, such as a tablet or smartphone used by a coach (Step 606). The play data is transmitted wirelessly and is position-specific, targeted to the individual player wearing the visor. Finally, the visor assembly 106 processes the received data and renders a position-specific view directly on the transparent display (Step 608). The view enables the player to visualize their unique assignment, such as a route or motion pattern, without leaving their stance or breaking formation.

FIG. 7 illustrates an exemplary remote device used in the present invention in accordance with the disclosed architecture. The processing unit 702 may include suitable logic, instructions, circuitry, interfaces, and/or codes for executing various operations, such as the operations associated with the remote device 102, or the like. The processing unit 702 may be configured to control one or more operations executed by the remote device 102 in response to the input received at the remote device 102 from the user. Examples of the processing unit 702 may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Embodiments of the present disclosure are intended to include or otherwise cover any type of the processing unit 702 including known, related art, and/or later developed processing units. The remote device 102 can further include one or more computer executable applications configured to be executed by the processing unit 702. The one or more computer executable applications may include suitable logic, instructions, and/or codes for executing various operations. The one or more computer executable applications may be stored in the memory 708.

The remote device 102 includes input device(s) 704 such as a touch input device, voice input device, etc. for entering data and information. Preferably, the touch interface of the remote device 102 is used as the input and various buttons/tabs that are pressed or clicked by the user. Other input devices such as camera and microphone are used during video capture. The display of the remote device 102 also acts as the output device 706 for displaying various contents (i.e., text, images, videos, icons, and/or symbols, etc.) to the user. The display can include a touch screen, and may receive, for example, a touch, gesture, proximity, or hovering input using an electronic pen or a part of a user's body.

The remote device 102 has memory 708 used for storing programs (sequences of instructions) or data (e.g., program state information). Memory 708 can be configured for short-term storage of information as volatile memory and therefore not retain stored contents if powered off. Examples of volatile memories include random access memories (RAM), dynamic random-access memories (DRAM), static random-access memories (SRAM), and other forms of volatile memories known in the art. The connection to a network is provided by wireless interface 710.

The wireless interface 710 enables the remote device 102 to wirelessly communicate with the server and other components of the system 100 over the communication network, according to embodiments of the present disclosure. Examples of the communication interface 710 may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “football training system, “football play heads-up display system”, “football play information display and training system”, and “system” are interchangeable and refer to the football play information display and training system 100 of the present invention.

Notwithstanding the foregoing, the football play information display and training system 100 of the present invention can be of any suitable configuration as is known in the art without affecting the overall concept of the invention, provided that it accomplishes the above stated objectives. One of ordinary skill in the art will appreciate that the football play information display and training system 100 as shown in the FIGS. are for illustrative purposes only, and that many other configurations of the football play information display and training system 100 are well within the scope of the present disclosure. Although the dimensions of the football play information display and training system 100 are important design parameters for user convenience, the football play information display and training system 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A football play heads-up display system comprising:
a football play heads-up display system having a visor, a football helmet, a remote device, and a wireless communication network;
wherein said remote device wirelessly connected to said visor through said wireless communication network;
wherein said visor attached to said football helmet in a wearer's line of sight;
wherein said remote device wirelessly transmits a digital play data through said wireless communication network;
wherein said visor receives said digital play data; and
further wherein said digital play data selected from the group consisting of a football play diagram, a football route, and a football assignment.

2. The football play heads-up display system of claim 1, wherein said visor having a transparent digital display configured to selectively display said digital play data.

3. The football play heads-up display system of claim 2, wherein said football play diagram having position-specific play data.

4. The football play heads-up display system of claim 3, wherein said digital play data is in real-time with said remote device.

5. The football play heads-up display system of claim 4, wherein said remote device selects, generates, and transmits said digital play data football in said real time to said visor.

6. The football play heads-up display system of claim 5, wherein said wireless communication network selected from the group consisting of a Bluetooth connection, a Wi-Fi connection, and a broadband connection.

7. The football play heads-up display system of claim 6, wherein said visor having a touch enabled digital display comprising at least one of said football play diagram, said football route, and said football assignment.

8. The football play heads-up display system of claim 7, wherein said visor having a processor for said receiving said digital display data.

9. The football play heads-up display system of claim 8, wherein said visor having a microphone for audio transmission between the wearer and said remote device.

10. The football play heads-up display system of claim 9, wherein each said visor having a unique identifier for transmitting a unique said digital display data to a specific wearer selected from the group consisting of a quarterback (QB), a running back (RB), a wide receiver (WR), a tight end (TE), and an offensive lineman (OL).

11. A football play heads-up display system comprising:
a football play heads-up display system having a visor, a football helmet, a remote device, and a wireless communication network;
wherein said remote device wirelessly connected to said visor through said wireless communication network;
wherein said visor attached to said football helmet in a wearer's line of sight;
wherein said remote device wirelessly transmits a digital play data through said wireless communication network;
wherein said visor receives said digital play data;
wherein said digital play data selected from the group consisting of a football play diagram, a football route, and a football assignment;
wherein said visor having a microphone for audio transmission between the wearer and said remote device; and
further wherein each said visor of a plurality of visors having a unique identifier for receiving a unique said digital display data from said remote device to a specific wearer.

12. The football play heads-up display system of claim 11, wherein said visor having a transparent digital display configured to selectively display said digital play data.

13. The football play heads-up display system of claim 12, wherein said football play diagram having position-specific play data.

14. The football play heads-up display system of claim 13, wherein said digital play data is in real-time with said remote device.

15. The football play heads-up display system of claim 14, wherein said remote device selects, generates, and transmits said digital play data football in said real time to said visor.

16. The football play heads-up display system of claim 15, wherein said visor having a touch enabled digital display comprising at least one of said football play diagram, said football route, and said football assignment.

17. The football play heads-up display system of claim 16, wherein said visor having a processor for said receiving said digital display data.

18. The football play heads-up display system of claim 17, wherein said visor having a microphone for audio transmission between the wearer and said remote device.

19. A method of transmitting digital football play data to a display system, the method comprising the steps of:
providing a football play heads-up display system having a visor, a football helmet, a remote device, and a wireless communication network;
wirelessly connecting said remote device to said visor through said wireless communication network;
attaching said visor to said football helmet in a wearer's line of sight;
wirelessly transmitting a digital play data through said wireless communication network from said remote device to said visor; and
receiving said digital play data to said visor, wherein said digital play data selected from the group consisting of a football play diagram, a football route, and a football assignment, further wherein said visor having a microphone for audio transmission between the wearer and said remote device.

20. The method of transmitting digital football play data to a display system of claim 19, wherein each said visor of a plurality of visors having a unique identifier for receiving a unique said digital display data from said remote device to a specific wearer.
